(19) United States
(12) Patent Application Publication
(10) Pub. No.: US 2004/0010401 A1
(43) Pub. Date: Jan. 15, 2004

(54) Unified simulation system and method for selectively including one or more cores in an integrated circuit simulation model

(75) Inventors: Maureen Terese Davis, Austin, TX (US); Hien Minh Le, Pflugerville, TX (US); Anh Tran Vinh, Austin, TX (US)

Correspondence Address: Gregory W. Carr, 670 Founders Square, 900 Jackson Street, Dallas, TX, 75202, US

(73) Assignee: International Business Machines Corporation, Armonk, NY

(21) Appl. No.: 10/195,170

(22) Filed: Jul. 11, 2002

(51) Int. Cl. G06F 17/50

(52) U.S. Cl. 703/14

(57) ABSTRACT

A unified simulation system is disclosed including multiple core design files, a control structure, a define file, and a compiler module. Each of the core design files includes a description of a corresponding core (i.e., functional block or unit) of an integrated circuit. The control structure associates each of multiple simulation levels with one or more of the core design files. The define file defines an active one of the multiple simulation levels. The compiler module uses the define file to determine the active simulation level, uses the control structure to determine the one or more core design files associated with the active simulation level, and uses the one or more core design files associated with the active simulation level to generate a simulation model of an integrated circuit. A user of the unified simulation system creating the define file can determine the simulation level achieved during subsequent simulation of the simulation model. A method is also described for forming the simulation model.

### BACKGROUND OF THE INVENTION

1. Field of the Invention

This invention relates generally to the design of integrated circuits and, more particularly, to systems and methods for generating simulation models of integrated circuits.

2. Description of the Related Art

Due to the high degree of complexity involved in modem integrated circuit (IC) design, the design of an IC typically includes capturing a design specification of the IC in a hardware description language (HDL), such as VHDL (very high speed integrated circuit hardware description language, IEEE standard 1076) or Verilog® (IEEE standard 1364; “Verilog” is a registered trade mark of Cadence Design Systems, Inc.). The resulting HDL description typically characterizes the IC at a level of abstraction, such as a register transfer level (RTL), or a behavioral level. A compiler is used to transform the HDL description into a “compiled model” of the IC. A simulator is then used to verify proper functional operation of the compiled model according to the design specification. Once the compiled model has been functionally verified, a synthesizer is used to map the compiled model to technology-specific logic gate structures, producing a logic level “netlist.” Following further functional verification and/or timing verification, suitable positions of the logic gate structures of the netlist relative to one another are determined. At this point, the IC design is complete, and the IC may be manufactured with a high degree of confidence that the IC will perform per the design specification.

When capturing the design specification in an HDL description, designers typically work with building blocks including multiple components, such as logic gates. In a similar manner, it is now possible for designers to take highly complex functional units or blocks, such as microprocessors, bus/network interfaces, signal processors, and integrate them into an IC much like other building blocks. Such functional units, commonly referred to as “cores,” are becoming increasingly available.

Application specific integrated circuits (ASICs) are designed to perform specific functions. ASICs are typically intended to be incorporated into consumer products to be marketed relatively soon, and are thus typically designed and manufactured relatively quickly. ASICs may be used, for example, to impart specific functionality to toys, communication devices, and interfaces (e.g., bus/network interfaces).

A typical IC simulation environment includes a user interface (e.g., a graphical user interface), an HDL compiler, and an HDL simulator. As IC (e.g., ASIC) designs become more complex, so do the simulation environments in which they are designed and tested.

Due in large part to the inherent modularity of the core designs, multiple simulation environments may be involved in the design of an IC having multiple cores. For example, a first simulation environment may be used to design and functionally verify one or more of the multiple cores. A second simulation environment, at a higher level than the first, may be used to verify proper connectivity and interaction between a subset of the cores (i.e., multi-core interaction). A third simulation environment, at a higher level than the second, may be used to verify proper functioning of the entire IC.

The multiple simulation environments involved create several problems. First, time is required to establish and maintain the multiple simulation environments. Second, as it is very helpful for designers of cores to also be involved in core integration, designers are required to become proficient in multiple simulation environments. In addition, if verification aids (e.g., test cases, verification monitors, and debugging aids) developed in one simulation environment are to be used in another simulation environment, the verification aids must be either ported to the other simulation environments, or redeveloped in the other simulation environment. Further, when a problem is found in a higher-level simulation environment, the problem may have to be solved in a lower-level simulation environment before retesting in the higher-level simulation environment.

### SUMMARY OF THE INVENTION

A unified simulation system is disclosed including multiple core design files, a control structure, a define file, and a compiler module. Each of the core design files includes a description of a corresponding core (i.e., functional block or unit) of an integrated circuit. The control structure associates each of multiple simulation levels with one or more of the core design files. The define file defines an active one of the multiple simulation levels. The compiler module uses the define file to determine the active simulation level, uses the control structure to determine the one or more core design files associated with the active simulation level, and uses the one or more core design files associated with the active simulation level to generate a simulation model of the integrated circuit. A user of the unified simulation system creating the define file can determine the simulation level achieved during subsequent simulation of the simulation model.

A method for forming a simulation model of an integrated circuit includes providing the multiple core design files and the control structure. The define file is formed and subsequently used to determine the active simulation level. The control structure is used to determine the one or more core design files associated with the active simulation level. The one or more core design files associated with the active simulation level are used to generate the simulation model. A computer product (e.g., a floppy disk, a compact disk read only memory or CD-ROM disk, and the like) is disclosed for forming the simulation model. The computer product has a medium with design source code and/or program instructions embodied thereon. The design source code provides the multiple core design files and the control structure. The design source code is intended as input to a compiler configured to use the design source code to generate the simulation model.

The disclosed system and method achieves a unified simulation environment or test vehicle for multiple levels of simulation and/or functional verification. In this unified simulation environment, only selected cores (e.g., cores being tested) are modeled at a relatively low level (e.g., an RTL level, a netlist level, or a netlist with standard delay format file level), while other cores that interact with the selected cores are modeled at a relatively high level (e.g., a behavioral level).

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of one embodiment of a unified simulation system including a central processing unit (CPU) coupled to a memory system, wherein the memory system includes multiple core design files, a simulation control file including a control structure, a define file, a compiler module, a simulator module, and a simulation model of an integrated circuit;

FIG. 2 is a diagram illustrating compiler and simulator functions performed by the simulation system of FIG. 1;

FIG. 3 is a diagram illustrating one embodiment of the simulation model of FIG. 1, wherein the simulation model includes a unit under test (UUT) used to model an integrated circuit having multiple cores, and wherein FIG. 3 graphically illustrates how the control structure of the simulation control file and the define file are used to determine if one of the cores, two of the cores, or all of the cores of the integrated circuit are modeled at a relatively low level in the UUT;

FIG. 4A is a diagram illustrating one embodiment of the simulation model of FIG. 3, wherein the UUT is used to model an integrated circuit having three cores that interact with each other, and wherein one of the three cores is a “selected” core modeled at the relatively low level, and the other two cores are “represented” cores modeled at a relatively high level (e.g., at a behavioral level);

FIG. 4B is a diagram illustrating one embodiment of the simulation model of FIG. 4A, wherein two of the three cores are selected cores modeled at the relatively low level, and the other core is a represented core modeled at the relatively high level;

FIG. 4C is a diagram illustrating one embodiment of the simulation model of FIG. 4A, wherein all three cores are selected cores modeled at the relatively low level; and

FIGS. 5A-5B in combination form a flow chart of one embodiment of a method for generating a simulation model of an integrated circuit.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system related and business related constraints, which will vary from one implementation to another. Moreover, it will be appreciated that such a development effort might be complex and time-consuming, but would nevertheless be a routine undertaking for those of ordinary skill in the art having the benefit of this disclosure.

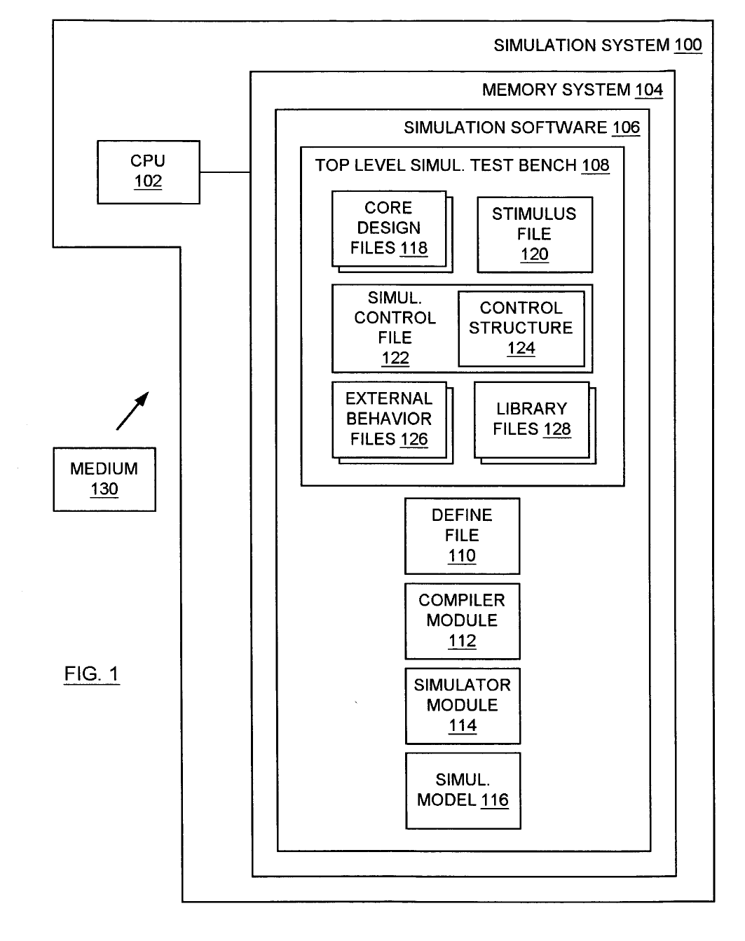

FIG. 1 is a diagram of one embodiment of a unified simulation system 100 including a central processing unit (CPU) 102 coupled to a memory system 104. The memory system 104 includes simulation software 106, and the simulation software 106 includes a top level simulation test bench 108, a define file 110, a compiler module 112, a simulator module 114, and a simulation model 116.

In the embodiment of FIG. 1, the top level simulation test bench 108 includes multiple core design files 118, a stimulus file 120, a simulation control file 122 including a control structure 124, multiple external behavior files 126, and multiple library files 128. Each of the core design files 118 includes a description of a corresponding core (i.e., functional block or unit) of an integrated circuit. In the embodiment of FIG. 1, each of the core design files 118 includes a design source code description of the corresponding core, wherein the design source code description is a textual description of the corresponding core written in a defined language. Suitable hardware description languages (HDLs) include the VHDL and Verilog® HDLs described above. Alternately, the language may be a high-level computer language, such as C or C++. The core design files 118 are typically created by engineers using design specifications for the cores.

Each of the external behavior files 126 includes a description of a corresponding external behavior required for simulation and/or functional verification of the integrated circuit. Examples of such external behaviors include bus functional models (BFMs) used to represent, for example, external processing units, memory units, input/output (I/O) units, and the like. In the embodiment of FIG. 1, each of the external behavior files 126 includes a design source code description of the corresponding external behavior, wherein the design source code description is a textual description of the corresponding external behavior written in a defined language. Suitable hardware description languages (HDLs) include the VHDL and Verilog® HDLs described above. Alternately, the language may be a high-level computer language, such as C or C++.

The stimulus file 120 includes stimulus (e.g., test patterns) intended to be provided to the simulation model 116 during simulation. The library files 128 include files and/or functions referenced by other files of the top level simulation test bench 108.

In general, the control structure 124 of the simulation control file 122 associates each of multiple simulation levels with one or more corresponding core design files 118, and/or with one or more of the external behavior files 126. The define file 110 defines which of the multiple simulation levels is active. Embodiments of the control structure 124 and the define file 110 are described in detail below.

The compiler module 112 includes program instructions executable by the CPU 102. When the CPU 102 executes the program instructions of the compiler module 112, the simulation system 100 performs a compiler function (i.e., implements a compiler). In general, the compiler translates design source code into modeling information according to a predefined set of rules, thereby producing the simulation model 116.

The top level simulation test bench 108 is compiled by the compiler to generate the simulation model 116. Generally speaking, when the compiler encounters the control structure 124 of the simulation control file 122, the compiler uses information in the define file 110 to determine which of the multiple simulation levels is active. The compiler uses information in the control structure 124 to determine which of the core design files 118 are associated with the active simulation level, and uses the core design files 118 associated with the active simulation level to generate the simulation model 116. The compilation process is described in more detail below.

The simulator module 114 includes program instructions executable by the CPU 102. When the CPU 102 executes the program instructions of the simulator module 114, the simulation system 100 performs a simulator function (i.e., implements a simulator). The simulator is used to simulate functional operation of portions of the integrated circuit via the simulation model 116. The simulator function is described in more detail below.

It is noted that while software embodiments of the compiler module 112 and the simulator module 114 are described herein, portions of the compiler module 112 and/or the simulator module 114 may be embodied within hardware.

As indicated in FIG. 1, a carrier medium 130 may be used to convey one or more components of the simulation software 106 to the simulation system 100. Generally speaking, the carrier medium 130 may be used to convey the core design files 118, the stimulus file 120, the simulation control file 122, the multiple external behavior files 126, the multiple library files 128, the define file 110, the compiler module 112, and/or the simulator module 114 to the simulation system 100. For example, the simulation system 100 may include a disk drive for receiving removable disks (e.g., a floppy disk drive, a compact disk read only memory or CD-ROM drive, and the like), and the carrier medium 130 may be a disk (e.g., a floppy disk, a CD-ROM disk, and the like) embodying software (e.g., computer program code) for performing the functions of one or more of the components of the simulation software 106.

In one embodiment, the compiler module 112 and/or the simulator module 114 may already exist within the simulation system 100. In this situation, the medium 130 may include some or all of the files of the top level simulation test bench 108. In other words, the medium 130 may include the multiple core design files 118, the stimulus file 120, the simulation control file 122 including the control structure 124, the multiple external behavior files 126, and/or the multiple library files 128.

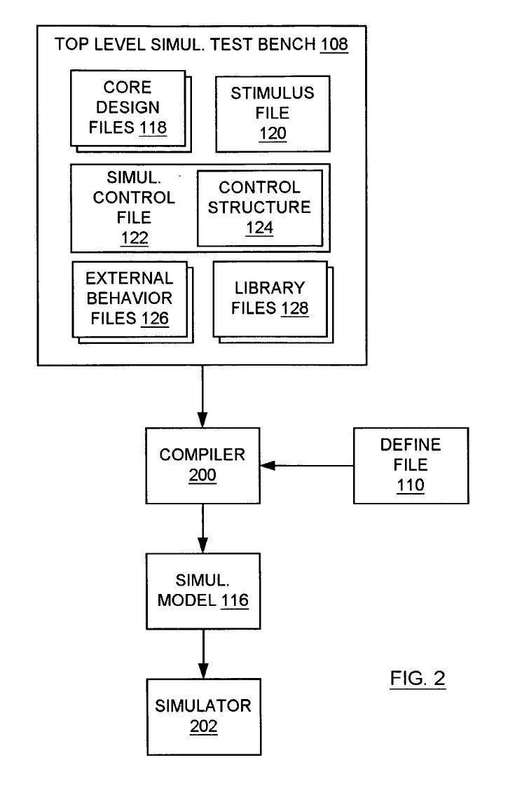

FIG. 2 is a diagram illustrating the compiler and simulator functions performed by the simulation system 100 of FIG. 1. As described above, when the CPU 102 (FIG. 1) executes the program instructions of the compiler module 112 of FIG. 1, the simulation system 100 performs a compiler function (i.e., implements a compiler labeled 200 in FIG. 2). In one embodiment, the control structure 124 of the simulation control file 122, and the define file 110, include compiler directives.

As indicated in FIG. 2, the compiler 200 is used to compile the top level test bench 108. During compilation of the top level test bench 108, the compiler 200 encounters the control structure 124 of the simulation control file 122. At this point, the compiler 200 uses information in the define file 110 to determine the active simulation level. The compiler 200 uses information in the control structure 124 to determine which of the core design files 118 is/are associated with the active simulation level. The compiler 200 includes in the design source code of the simulation control file 122 the design source code of the core design files 118 associated with the active simulation level. The compiler 200 may also include in the design source code of the simulation control file 122 the design source code of any external behavior files 126 corresponding to the core design files 118 associated with the active simulation level. The compiler 200 uses the resulting design source code to produce the simulation model 116.

The compiler 200 may also include design source code of one or more library files 128, and/or the stimulus file 120, of the top level simulation test bench 108 in the design source code of the simulation control file 122 according to other compiler directives, and use the resulting design source code to produce the simulation model 116. As described above, the resultant simulation model 116 includes modeling information used to simulate functional operation of portions of the integrated circuit.

The define file 110 is typically created by a user of the simulation system 100. In one embodiment, the define file 110 includes a ‘define’ compiler directive that defines the active simulation level. For example, the multiple simulation levels may include a single core level (i.e., a ‘CORE’ level), a multiple core level (i.e., a ‘MULTICORES’ level), and a chip level (i.e., a ‘CHIP’ level). A Verilog® version of the define file 110 may include, for example, the following Verilog® ‘define’ statement to define the ‘CORE’ level as the active simulation level:

`define CORE 1

It is noted that all Verilog® compiler directives are preceded by the accent grave character (`). In typical use, the above Verilog® ‘define’ statement directs a compiler to substitute ‘1’ for each subsequent occurrence of ‘CORE’ encountered in input design source code.

Similarly, a Verilog® version of the define file 110 may include the following Verilog® ‘define’ statement to define the ‘MULTICORES’ level as the active simulation level:

`define MULTICORES 1

A Verilog® version of the define file 110 may include the following Verilog® ‘define’ statement to define the ‘CHIP’ level as the active simulation level:

`define CHIP 1

The simulation control file 122 is typically created by an engineer as part of the top level simulation test bench 108. The control structure 124 of the simulation control file 122 may include, for example, multiple ‘ifdef’ compiler directive statements, one for each of the multiple simulation levels. Each of the ‘ifdef’ statements may associate one of the simulation levels with the corresponding core design files 118, and with any corresponding external behavior files 126.

A Verilog® version of the control structure 124 of the simulation control file 122 for an integrated circuit modeled as having 3 cores may include, for example, the following Verilog® ‘ifdef’ statements:

′ifdef CORE

′include “core1_design_file.v”
′include “core1_external_behavior.v”

′endif
′ifdef MULTICORES
′include “core1_design_file.v”

′include “core2_design_file.v”
′include “core1_external_behavior.v”
′include “core2_external_behavior.v”

′endif
′ifdef CHIP
′include “core1_design_file.v”

′include “core2_design_file.v”

′include “core3_design_file.v”

′include “core1_external_behavior.v”
′include “core2_external_behavior.v”

′include “core3_external_behavior.v”
′endif

The Verilog® ‘ifdef’ statement is used to optionally include lines of design source code during compilation. When the compiler encounters an ‘ifdef <variable name>’ statement, the compiler checks to see if the variable name has been defined. If the variable name has been defined, the lines of design source code between the ‘ifdef’ statement and a corresponding ‘endif’ statement are included (i.e., compiled). On the other hand, if the variable name has not been defined, the lines of design source code between the ‘ifdef’ statement and a corresponding ‘endif’ statement are not included (i.e., not compiled). The ‘include <file name>’ compiler directive directs the compiler to insert the entire contents of the file named <file name> during compilation.

In the above example, each of the 3 cores of the integrated circuit has a corresponding core design file “coren_design_file.v,” where n is a number between 1 and 3 assigned to the core. Each of the 3 cores also has a corresponding external behavior file “coren_external_behavior_file.v” in the above example.

For example, assume a Verilog® version of the define file 110 includes the following Verilog® ‘define’ statement:

`define CORE 1

When the compiler 200 compiles the above Verilogg version of the control structure 124 of the simulation control file 122, the compiler 200 would compile the following statements:

`include “corel_design_file.v”

`include “corel_external_behavior.v”

and would include the entire contents of the “corel_design_file.v” file and the “corel_external_behavior.v” file in the simulation control file 122 during compilation. The “corel_design file.v” file is the core design file corresponding to a core numbered ‘1’ of the integrated circuit, and the “corel_external_behavior.v” file is the external behavior file corresponding to the core numbered ‘1.’

It is noted that for each of the multiple simulation levels, other files including design source code to handle, for example, configuration and/or post-processing functions, may also be included with the corresponding core design files and external behavior files between the ‘ifdef’ and ‘endif’ compiler directives. The configuration files may include, for example, functions to be performed before and/or after a RESET signal occurs.

Cores of an integrated circuit not selected for modeling at a relatively low level (e.g., an RTL level, a netlist level, or a netlist with standard delay format file level) in the simulation model 116, and that interact with the “selected” cores, may be advantageously modeled at a relatively high level (e.g., at a behavioral level). Behavioral models are often simpler, easier to develop and maintain, and more reliable than lower level models. Advantages of using simpler behavioral models to represent non-selected cores that interact with selected cores include faster simulations and fewer modeling errors during simulations.

As described above, when the CPU 102 (FIG. 1) executes the program instructions of the simulator module 114 (FIG. 1), the simulation system 100 (FIG. 1) performs a simulation function (i.e., implements a simulator labeled 202 in FIG. 2). The simulator 202 may, for example, be used to verify that the simulation model 116 performs according to the design specification (e.g., to perform functional verification of the simulation model 116). During simulation of the simulation model 116, stimulus (e.g., test patterns) from the stimulus file 120 of the top level simulation test bench 108 may be provided to the simulation model 116. The simulation model 116 expectedly responds to the input stimulus by producing a result. The result may be obtained from the simulation model 116, and compared to an expected result derived from the design specification. If the result matches the expected result, the simulation model 116 (and the corresponding portion of the IC) may be viewed as functioning correctly. If, on the other hand, the result does not match the expected result, the simulation model 116 (and the corresponding portion of the IC) may be viewed as functioning improperly, and corrective action may be taken.

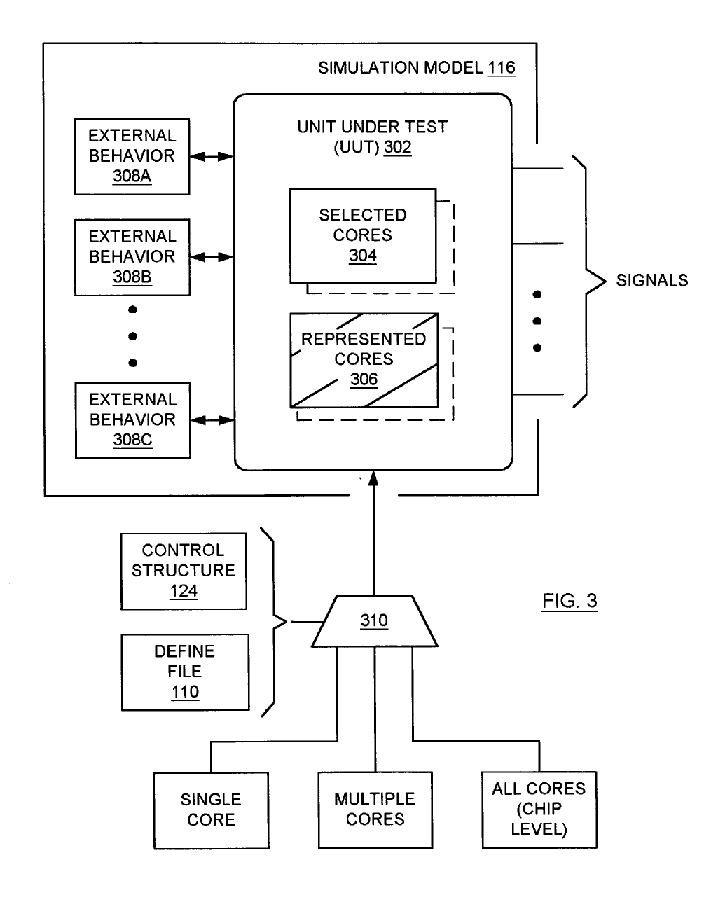

FIG. 3 is a diagram illustrating one embodiment of the simulation model 116 of FIG. 1, wherein the simulation model 116 includes a unit under test (UUT) 302 and multiple corresponding external behaviors 308A-308C. The UUT 302 is used to model an integrated circuit having multiple cores. In the embodiment of FIG. 3, the UUT 302 includes one or more selected cores 304, and one or more represented cores 306. FIG. 3 also graphically illustrates the control structure 124 of the simulation control file 122 (FIGS. 1-2), and the define file 110, as inputs to a selection function 310 at compile time, thereby determining if a single one of the cores, multiple cores, or all of the cores of the integrated circuit become the “selected” cores 304 in the UUT 302. The represented cores 306 are “non-selected” cores that interact with the selected cores 304, and are represented by simplified behavioral models.

The selected cores 304 may include a single one of the cores, multiple cores, or all of the cores of the integrated circuit. Each of the cores of the integrated circuit has a corresponding core design file (e.g., a corresponding one of the core design files 118 in FIGS. 1-2). During compilation, only the core design files corresponding to the selected cores 304 are modeled at a relatively low level (e.g., an RTL level, a netlist level, or a netlist with standard delay format file level) in the UUT 302 by the compiler 200 (FIG. 2) as described above. The selection function 310 occurs during compilation dependent upon the control structure 124 and the define file 110.

The selected cores 304 interact with the external behaviors 308A-308C. Each of the external behaviors 308A-308C has a corresponding external behavior file (e.g., a corresponding one of the external behavior files 124 in FIGS. 1-2). The corresponding external behavior files are also included in the UUT 302 by the compiler 200 at compile time via the selection function 310.

In FIG. 3, multiple signals are used to communicate with the UUT 302 during simulation. These signals may include, for example, synchronizing signals, reset signals, monitoring signals, and the like. The signals may be used to implement, for example, waveform capturing mechanisms, core synchronization mechanisms, completion detection mechanisms, hang condition detection mechanisms, and/or post processing mechanisms.

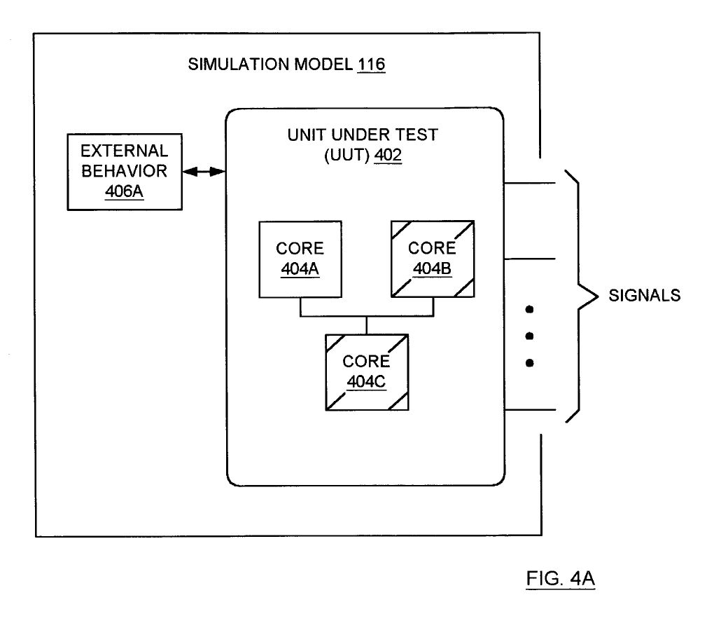

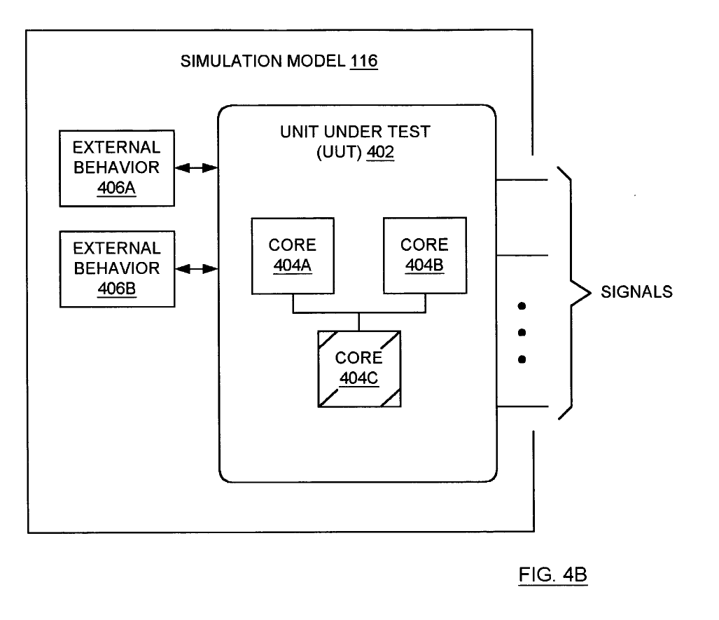

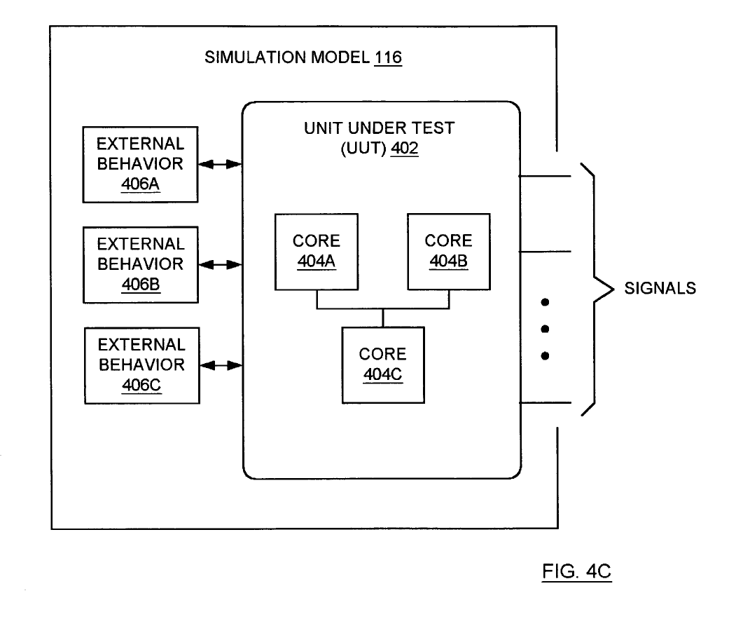

FIG. 4A is a diagram illustrating one embodiment of the simulation model 116 of FIG. 3, wherein the simulation model 116 includes a unit under test (UUT) 402 and a single external behavior 406. The UUT 402 is used to model an integrated circuit having three cores 404A, 404B, and 404C that interact with each other. In the embodiment of FIG. 4A, core 404A is a selected core, and the two cores 404B and 404C are represented cores. The core design file corresponding to the selected core 404A is included in the simulation control file 122 (FIGS. 1-2) by the compiler 200 (FIG. 2) at compile time as described above, and is modeled at a relatively low level (e.g., an RTL level, a netlist level, or a netlist with standard delay format file level) in the UUT 402. The represented cores 404B and 404C interact with the selected core 404A, and are represented by simplified behavioral models. The core 404A also interacts with the external behavior 406A during operation, and the external behavior file corresponding to the external behavior 406A is included in the UUT 402 by the compiler 200 (FIG. 2) at compile time.

FIG. 4B is a diagram illustrating one embodiment of the simulation model 116 of FIG. 4A, wherein the cores 404A and 404B are selected cores, and the core 404C is a represented core. The core design files corresponding to the selected cores 404A and 404B are included in the simulation control file 122 (FIGS. 1-2) by the compiler 200 (FIG. 2) at compile time as described above, and are modeled at a relatively low level (e.g., an RTL level, a netlist level, or a netlist with standard delay format file level) in the UUT 402. The represented core 404C interacts with the selected cores 404A and 404B, and is represented by a simplified behavioral model.

In the embodiment of FIG. 4B, the simulation model 116 includes external behaviors 406A and 406B. The core 404A interacts with the external behavior 406A during operation, and the core 404B interacts with the external behavior 406B during operation. External behavior files corresponding to the external behaviors 406A and 406B are included in the UUT 402 by the compiler 200 (FIG. 2) at compile time.

FIG. 4C is a diagram illustrating one embodiment of the simulation model 116 of FIG. 4A, wherein all three cores 404A-404C are selected cores. The core design files corresponding to the selected cores 404A-404C are included in the simulation control file 122 (FIGS. 1-2) by the compiler 200 (FIG. 2) at compile time as described above, and are modeled at a relatively low level (e.g., an RTL level, a netlist level, or a netlist with standard delay format file level) in the UUT 402.

In the embodiment of FIG. 4C, the simulation model 116 includes three external behaviors 406A-406C. The core 404A interacts with the external behavior 406A during operation, the core 404B interacts with the external behavior 406B during operation, and the core 404C interacts with the external behavior 406C during operation. The external behavior files corresponding to the external behaviors 406A-406C are included in the UUT 402 by the compiler 200 (FIG. 2) at compile time.

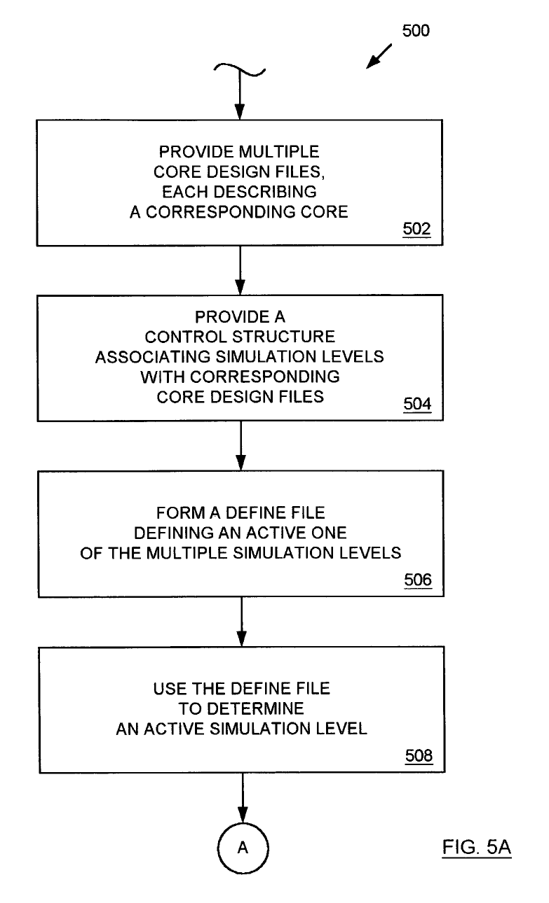

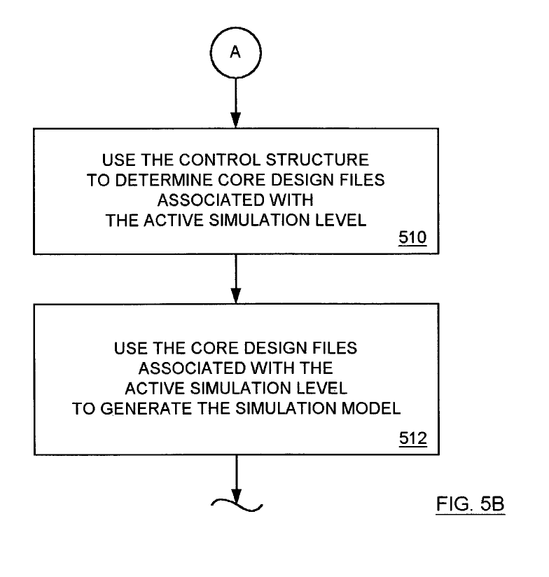

FIGS. 5A-5B in combination form a flow chart of one embodiment of a method 500 for generating a simulation model of an integrated circuit. The method 500 reflects steps a user of the unified simulation system 100 (FIG. 1) may take, for example, to generate the simulation model 116 (FIGS. 1-2). During a step 502 of the method 500, multiple core design files (e.g., core design files 118 of FIGS. 1-2) are provided. As described above, each of the core design files 118 may include, for example, a design source code description of a corresponding core of an integrated circuit.

During a step 504, a control structure (e.g., the control structure 124 of FIGS. 1-3) is provided that associates each of multiple simulation levels with one or more corresponding core design files (e.g., the corresponding core design files 118 of FIGS. 1-2). As described above and illustrated in FIG. 3, the multiple simulation levels may include a single core (e.g., the core level), multiple cores (i.e., the multi-core level), and all cores (i.e., the chip level).

It is noted that the user of the simulation system 100 (FIG. 1) may perform the steps 502 and 504 by using the medium 130 (FIG. 1) to convey some or all of the files of the top level simulation test bench 108 (FIGS. 1-2) to the simulation system 100 (FIG. 1).

During a step 506, a define file is formed that defines an active one of multiple simulation levels. As described above, the user of the simulation system 100 (FIG. 1) may form the define file 110 (FIG. 1) to define which of the multiple simulation levels is active (e.g., the core level, the multi-core level, or the chip level). For example, as described above, the user may include in the define file 110 a ‘define’ compiler directive that indicates which of the simulation levels is active.

During a step 508, the define file is used to determine the active simulation level. The control structure is used to determine the core design files associated with the active simulation level during a step 510. During a step 512, the core design files associated with the active simulation level are used to generate the simulation model.

The user of the simulation system 100 (FIG. 1) may accomplish steps 508, 510, and 512 via a compiler (e.g., the compiler 200 of FIG. 2). Generally speaking, the steps 508, 510, and 512 may be performed by the compiler 200 (FIG. 2) while compiling the top level simulation test bench 108 (FIGS. 1-2). More specifically, the CPU 102 (FIG. 1) of the simulation system 100 (FIG. 1) performs the steps 508, 510, and 512 while executing program instructions of the compiler module 112 (FIG. 1). As described above, when the CPU 102 executes program instructions of the compiler module 112, the simulation system 100 implements the compiler 200.

Benefits of the above described unified simulation system and method are many. Chip connectivity achieved at the core level is reused at higher simulation levels. For one integrated circuit design, approximately 80 percent of chip connectivity required at the multi-core simulation level was achieved at the core level. Core protocol monitors and event monitors, used to verify core functionality, were generally reusable at the multi-core level. This is in contrast to conventional simulation environments where differences in hierarchies and/or naming conventions of multiple test benches often require monitors used at the core level to be modified before they can be used at the multi-core level. Monitors and names are easily referenced between levels of simulation using a global variable, which allows engineers to correct naming problems by editing only one design source code line. Few changes (if any) are needed to core level test cases to use the test cases at the multi-core level. Engineers require very little training to move between the multiple simulation levels. A design error found at one simulation level, and corrected at that level, is simultaneously corrected for all simulation levels. The different simulation levels are synchronized via a single environment, making the environment more reliable. As design time is reduced, productivity and quality are increased.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A simulation system, comprising:
a plurality of core design files, wherein each of the core design files comprises a description of a corresponding core of an integrated circuit;
a control structure associating each of a plurality of simulation levels with at least one corresponding core design file;
a define file defining which of the simulation levels is active; and
a compiler module configured to use the define file to determine the active simulation level, to use the control structure to determine the at least one of the core design files associated with the active simulation level, and to use the at least one core design file associated with the active simulation level to generate a simulation model of an integrated circuit.

2. The simulation system as recited in claim 1, wherein each of the core design files comprises a design source code description of the corresponding core.

3. The simulation system as recited in claim 2, wherein the design source code description comprises a textual description written in a hardware description language.

4. The simulation system as recited in claim 1, wherein each of the core design files comprises a textual description of the corresponding core comprising Verilog® hardware description language statements.

5. The simulation system as recited in claim 1, wherein each core is a predefined functional unit of the integrated circuit.

6. The simulation system as recited in claim 1, wherein the plurality of simulation levels comprises a core simulation level, a multi-core simulation level, and a chip-level simulation level.

7. The simulation system as recited in claim 6, wherein the control structure associates the core simulation level with a single one of the core design files.

8. The simulation system as recited in claim 6, wherein the control structure associates the multi-core simulation level with more than one of the core design files, and less than all of the core design files.

9. The simulation system as recited in claim 6, wherein the control structure associates the chip-level simulation level with all of the core design files.

10. The simulation system as recited in claim 1, wherein the define file comprises a compiler directive that indicates which of the simulation levels is active.

11. The simulation system as recited in claim 10, wherein the compiler directive comprises a ‘define’ compiler directive.

12. The simulation system as recited in claim 1, wherein the control structure comprises a plurality of compiler directives that associate each of the simulation levels with the at least one corresponding core design file.

13. The simulation system as recited in claim 12, wherein the compiler directives comprise ‘ifdef’ compiler directives.

14. The simulation system as recited in claim 1, wherein the integrated circuit comprises an application specific integrated circuit.

15. A method for forming a simulation model of an integrated circuit, comprising:
providing a plurality of core design files, wherein each of the core design files comprises a description of a corresponding core of the integrated circuit;
providing a control structure associating each of a plurality of simulation levels with at least one corresponding core design file;
defining an active one of the simulation levels;
determining an active one of the simulation levels;
using the control structure to determine the at least one of the core design files associated with the active simulation level; and
using the at least one core design file associated with the active simulation level to generate the simulation model.

16. The method as recited in claim 15, wherein the step of defining the active one of the simulation levels further comprises:
forming a define file comprising a compiler directive that indicates which of the simulation levels is active.

17. The method as recited in claim 15, wherein the step of providing the plurality of core design files further comprises:
providing a plurality of core design files, each comprising a design source code description of a corresponding core of the integrated circuit.

18. The method as recited in claim 15, wherein the step of providing the plurality of core design files further comprises:
providing a plurality of core design files, each comprising a textual description of a corresponding core of the integrated circuit written in a hardware description language.

19. The method as recited in claim 15, wherein the step of providing the control structure comprises:
providing a control structure associating each of a plurality of simulation levels with at least one corresponding core design file, wherein the control structure comprises design source code, and wherein the plurality of simulation levels comprises a core simulation level, a multi-core simulation level, and a chip-level simulation level.

20. The method as recited in claim 15, wherein the step of providing the control structure comprises:
providing a control structure associating each of a plurality of simulation levels with at least one corresponding core design file, wherein the control structure comprises a plurality of compiler directives, and wherein the plurality of simulation levels comprises a core simulation level, a multi-core simulation level, and a chip-level simulation level.

21. A computer product for forming a simulation model, the computer program product having a medium with design source code embodied thereon, the design source code comprising:
design source code providing a plurality of core design files, wherein each of the core design files comprises a description of a corresponding core of the integrated circuit;
design source code providing a control structure associating each of a plurality of simulation levels with at least one of the core design files; and
wherein the design source code comprises input to a compiler configured to use the design source code to generate the simulation model.
